(19) United States
(12) Patent Application Publication
(10) Pub. No.: US 2015/0362945 A1
(43) Pub. Date: Dec. 17, 2015

(54) INTERNAL VOLTAGE GENERATION CIRCUIT OF SEMICONDUCTOR APPARATUS

(71) Applicant: SK hynix Inc., Icheon-si (KR)

(72) Inventor: Myung Hwan LEE, Icheon-si (KR)

(21) Appl. No.: 14/487,722

(22) Filed: Sep. 16, 2014

(30) Foreign Application Priority Data
Jun. 12, 2014 (KR) 10-2014-0071263

(51) Int. Cl. G05F 5/00

(52) U.S. Cl. CPC G05F 5/00

(57) ABSTRACT

An internal voltage generation circuit may include a first internal voltage generation block configured for receiving a first external voltage and for generating an internal voltage with a voltage level corresponding to a voltage level of a first reference voltage; and a second internal voltage generation block configured for receiving a second external voltage, generate the internal voltage with a voltage level corresponding to a voltage level of a second reference voltage, compare voltage levels of the second reference voltage and the internal voltage, and generate a comparison signal, wherein only one of the first and second internal voltage generation blocks is activated and the other is deactivated, in response to an enable signal, and the second internal voltage generation block disables the comparison signal to a voltage level of the first external voltage when the first internal voltage generation block is activated.

### CROSS-REFERENCES TO RELATED APPLICATION

The present application claims priority under 35 U.S.C. §119(a) to Korean application number 10-2014-0071263, filed on Jun. 12, 2014, in the Korean Intellectual Property Office, which is incorporated herein by reference in its entirety.

### BACKGROUND

1. Technical Field

Various embodiments generally relate to semiconductor integrated circuits, and more particularly, to an internal voltage generation circuits of semiconductor apparatuses or generally to internal voltage generation circuits.

2. Related Art

A semiconductor apparatus may be configured to receive voltage from an exterior source located outside the semiconductor apparatus. After receiving the external voltage the semiconductor apparatus may internally generate a voltage having a necessary voltage level, and use the generated voltage.

A circuit for changing the voltage received from outside the semiconductor apparatus into the voltage with the necessary voltage level within the semiconductor apparatus is referred to as an internal voltage generation circuit. The voltage applied from the exterior is referred to as an external voltage, and the voltage generated internally is referred to as an internal voltage.

The operation of a semiconductor apparatus may vary but trends remain towards lower power consumption. Additionally, the voltage level of an internal voltage may vary, and an amount of current for generating the internal voltage may tend to decrease.

### SUMMARY

In an embodiment, an internal voltage generation circuit may include a first internal voltage generation block configured for receiving a first external voltage and for generating an internal voltage having a voltage level corresponding to a voltage level of a first reference voltage. The internal voltage generation circuit may also include second internal voltage generation block configured for receiving a second external voltage, generate the internal voltage having a voltage level corresponding to a voltage level of a second reference voltage, compare voltage levels of the second reference voltage and the internal voltage, and generate a comparison signal. Also, only one of the first and second internal voltage generation blocks may be activated and the other may be deactivated, in response to an enable signal, and the second internal voltage generation block may disable the comparison signal to a voltage level of the first external voltage when the first internal voltage generation block is activated.

In an embodiment, an internal voltage generation circuit may include a first internal voltage generation block including a first comparison unit which may be configured to compare voltage levels of a first reference voltage and a first divided voltage when an enable bar signal is enabled and generate a first comparison signal, a first driving unit which may be configured to apply a first external voltage to an output node in response to the first comparison signal, and a first internal voltage generation unit configured to divide a voltage of the output node and generate the first divided voltage. The internal voltage generation circuit may also include a second internal voltage generation block including a second comparison unit which is configured to compare voltage levels of a second reference voltage and a second divided voltage in response to an enable signal and generate a preliminary comparison signal, a comparison signal control unit which is configured to output the preliminary comparison signal as a second comparison signal in response to the enable bar signal, a second driving unit which is configured to apply a second external voltage to the output node in response to the second comparison signal, and a second internal voltage generation unit which is configured to divide a voltage of the output node and generate the second divided voltage.

In an embodiment, an internal voltage generation circuit may include a first internal voltage generation block configured for receiving a first external voltage, and for generating an internal voltage. The internal voltage generation circuit may also include a second internal voltage generation block configured to be applied with a second external voltage, and generate the internal voltage in response to a comparison signal for a predetermined period, wherein the second internal voltage generation block generates the comparison signal which transitions to the second external voltage and a voltage level of a ground terminal, for the predetermined period, and locks the comparison signal to a voltage level of the first external voltage, for a period excluding the predetermined period, and wherein an output terminal of the first internal voltage generation block and an output terminal of the second internal voltage generation block are commonly electrically coupled to an output node, and the internal voltage is outputted from the output node.

### BRIEF DESCRIPTION OF THE DRAWINGS

FIG. 1 is a configuration diagram illustrating a representation of an example of an internal voltage generation circuit of a semiconductor apparatus or generally an internal voltage generation circuit in accordance with an embodiment.

FIG. 2 is a configuration diagram illustrating a representation of an example of an internal voltage generation circuit of a semiconductor apparatus or generally an internal voltage generation circuit in accordance with an embodiment.

FIG. 3 illustrates a block diagram of an example of a representation of a system employing the internal voltage generation circuit of a semiconductor apparatus or generally an internal voltage generation circuit in accordance with the embodiments discussed above with relation to FIGS. 1-2.

### DETAILED DESCRIPTION

Hereinafter, an internal voltage generation circuit of a semiconductor apparatus or generally an internal voltage generation circuit will be described below with reference to the accompanying drawings through various examples of embodiments.

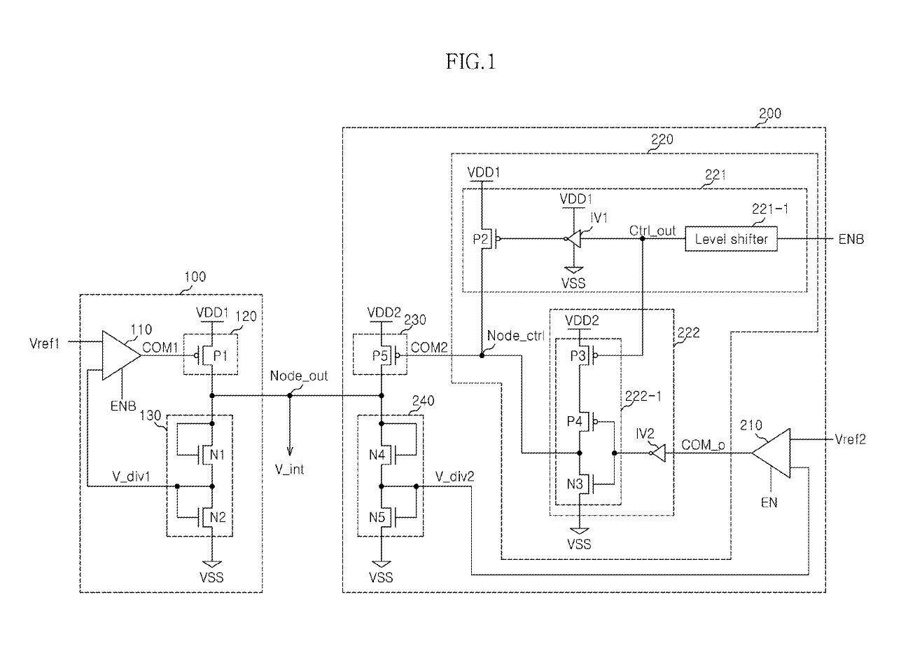

Referring to FIG. 1, an internal voltage generation circuit of a semiconductor apparatus in accordance with an embodiment may include a first internal voltage generation block 100, and a second internal voltage generation block 200. The output terminal of the first internal voltage generation block 100 and the output terminal of the second internal voltage generation block 200 may be commonly electrically coupled to an output node Node_out. An internal voltage V_int may be outputted from the output node Node_out.

The first internal voltage generation block 100 may be activated in response to an enable signal EN. The activated first internal voltage generation block 100 may generate the internal voltage V_int which may have a voltage level corresponding to the voltage level of a first reference voltage Vref1.

The first internal voltage generation block 100 may include a first comparison unit 110, a first driving unit 120, and a first voltage division unit 130.

The first comparison unit 110 may compare the voltage levels of the first reference voltage Vref1 and a first divided voltage V_div1 in response to the enable signal EN, and may generate a first comparison signal COM1. For example, the first comparison unit 110 is determined in terms of whether to be activated, in response to the enable signal EN. The activated first comparison unit 110 may compare the voltage level of the first reference voltage Vref1 and the voltage level of the first divided voltage V_div1, and may generate the first comparison signal COM1. The first comparison unit 110 may be inputted with an enable bar signal ENB (as illustrated in FIG. 1) which has a level opposite to the enable signal EN.

The first driving unit 120 may be applied with a first external voltage VDD1, and may apply a voltage to the output node Node_out in response to the first comparison signal COM1. For example, the first driving unit 120 may apply a voltage to the output node Node_out when the first comparison signal COM1 is enabled (i.e., is at a predetermined level), and may interrupt the application of a voltage to the output node Node_out when the first comparison signal COM1 is disabled (i.e., is at a predetermined level).

The first driving unit 120 may include a first transistor P1. The first transistor P1 may have a gate which may be inputted with the first comparison signal COM1, the source may be applied with the first external voltage VDD1, and the drain may be electrically coupled with the output node Node_out.

The first voltage division unit 130 may divide the voltage of the output node Node_out, and may generate the first divided voltage V_div1.

The first voltage division unit 130 may include second and third transistors N1 and N2. The second transistor N1 may have a gate and a drain which may be electrically coupled to the output node Node_out. The third transistor N2 may have a gate and a drain which may be electrically coupled to the source of the second transistor N1, and the source may be electrically coupled with a ground terminal VSS. The first divided voltage V_div1 may be outputted from a node at which the second and third transistors N1 and N2 are electrically coupled.

The second internal voltage generation block 200 may be determined in terms of whether to be activated, in response to the enable signal EN. The activated second internal voltage generation block 200 may generate the internal voltage V_int which may have a voltage level corresponding to the voltage level of a second reference voltage Vref2. In this regard, between the first internal voltage generation block 100 and the second internal voltage generation block 200, only one internal voltage generation block may be activated in response to the enable signal EN.

The second internal voltage generation block 200 may include a second comparison unit 210, a comparison signal control unit 220, a second driving unit 230, and a second voltage division unit 240.

The second comparison unit 210 may be determined in terms of whether to be activated, in response to the enable signal EN. The activated second comparison unit 210 may compare the voltage levels of the voltage of the output node Node_out, that is, the internal voltage V_int, and the second reference voltage Vref2, and may generate a preliminary comparison signal COM_p. For example, when activated in response to the enable signal EN, the second comparison unit 210 may compare the voltage levels of a second divided voltage V_div2, which is generated by dividing the internal voltage V_int, and the second reference voltage Vref2, and may generate the preliminary comparison signal COM_p.

The comparison signal control unit 220 may control the voltage level of the preliminary comparison signal COM_p in response to the enable signal EN, and may output a second comparison signal COM2. For example, the comparison signal control unit 220 may output the preliminary comparison signal COM_p as the second comparison signal COM2 when the enable signal EN is enabled (i.e., is at a predetermined level), and may disable the second comparison signal COM2 to a voltage level higher than a voltage level at which the second comparison signal COM2 is disabled (i.e., is at a predetermined level), when the enable signal EN is disabled.

The comparison signal control unit 220 may include a disable voltage control section 221, and a comparison signal transmitting section 222.

The disable voltage control section 221 may apply the first external voltage VDD1 to a control node Node_ctrl when the enable signal EN is disabled (i.e., is at a predetermined level), that is, when the enable bar signal ENB is enabled. Also, the disable voltage control section 221 may disable an output control signal Ctrl_out when the enable bar signal ENB is enabled (i.e., is at a predetermined level). The second comparison signal COM2 may be outputted from the control node Node_ctrl. That is to say, the voltage level of the control node Node_ctrl may be the voltage level of the second comparison signal COM2.

The disable voltage control section 221 may include a level shifter 221-1, a first inverter IV1, and a fourth transistor P2.

The level shifter 221-1 may be inputted with the enable bar signal ENB, and may control the voltage level of the enable bar signal ENB. For example, the level shifter 221-1 may output the enable bar signal ENB which transitions to the first external voltage VDD1 or the voltage level of the ground terminal VSS, as the output control signal Ctrl_out which transitions to a second external voltage VDD2 or the voltage level of the ground terminal VSS. The level shifter 221-1 may generate the output control signal Ctrl_out which may be enabled to the voltage level of the ground terminal VSS, if the enable bar signal ENB which is disabled to the voltage level of the ground terminal VSS is inputted. The level shifter 221-1 may generate the output control signal Ctrl_out which is disabled to the voltage level of the first external voltage VDD1, if the enable bar signal ENB which is enabled to the voltage level of the second external voltage VDD2 is inputted. The voltage level of the first external voltage VDD1 may be higher than the voltage level of the second external voltage VDD2.

The first inverter IV1 may invert the output control signal Ctrl_out and may output an output signal to the fourth transistor P2.

The fourth transistor P2 may have a gate which may be inputted with the output signal of the first inverter IV1, a source which may be applied with the first external voltage VDD1, and a drain that may be electrically coupled to the control node Node_ctrl.

The comparison signal transmitting section 222 may output the preliminary comparison signal COM_p as the second comparison signal COM2 when the output control signal Ctrl_out is enabled (i.e., is at a predetermined level), and may prevent the preliminary comparison signal COM_p from being outputted as the second comparison signal COM2 when the output control signal Ctrl_out is disabled (i.e., is at a predetermined level). For example, the comparison signal transmitting section 222 may enable the second comparison signal COM2 when the output control signal Ctrl_out is enabled and the preliminary comparison signal COM_p is enabled. The comparison signal transmitting section 222 may disable the second comparison signal COM2 when the output control signal Ctrl_out is enabled and the preliminary comparison signal COM_p is disabled. The comparison signal transmitting section 222 may float the control node Node_ctrl regardless of the preliminary comparison signal COM_p when the output control signal Ctrl_out is disabled. The comparison signal transmitting section 222 may output the second comparison signal COM2 to the control node Node_ctrl, and the voltage level of the control node Node_ctrl may be the voltage level of the second comparison signal COM2.

The comparison signal transmitting section 222 may include a second inverter IV2 and an output controller 222-1. The second inverter IV2 may be inputted with the preliminary comparison signal COM_p.

The output controller 222-1 may invert the output of the second inverter IV2 in response to the output control signal Ctrl_out and may output the second comparison signal COM2. For example, the output controller 222-1 may invert the output of the second inverter IV2 in response to the output control signal Ctrl_out and may output the second comparison signal COM2 when the output control signal Ctrl_out is enabled to a low level, that is, the voltage level of the ground terminal VSS.

The output controller 222-1 may include fifth to seventh transistors P3, P4 and N3. The fifth transistor P3 may have a gate which may be inputted with the output control signal Ctrl_out and a source which may be applied with the second external voltage VDD2. The sixth transistor P4 may have a gate which may be inputted with the output of the second inverter IV2 and a source that may be electrically coupled with a drain of the fifth transistor P3. The seventh transistor N3 may have a gate which may be inputted with the output of the second inverter IV2, a drain electrically coupled with the drain of the sixth transistor P4 and a source electrically coupled with the ground terminal VSS. The second comparison signal COM2 may be outputted from a node at which the sixth and seventh transistors P4 and N3 are electrically coupled. In other words, the node at which the sixth and seventh transistors P4 and N3 are electrically coupled may be electrically coupled to the control node Node_ctrl.

The second driving unit 230 may output the second external voltage VDD2 to the output node Node_out in response to the second comparison signal COM2. For example, the second driving unit 230 may apply the second external voltage VDD2 to the output node Node_out when the second comparison signal COM2 is enabled, and may interrupt the application of the second external voltage VDD2 to the output node Node_out when the second comparison signal COM2 is disabled.

The second driving unit 230 may include an eighth transistor P5. The eighth transistor P5 may have a gate that may be inputted with the second comparison signal COM2, a source that may be applied with the second external voltage VDD2 and a drain electrically coupled with the output node Node_out.

The second voltage division unit 240 may divide the voltage of the output node Node_out, and may generate the second divided voltage V_div2.

The second voltage division unit 240 may include ninth and tenth transistors N4 and N5. The ninth transistor N4 may have a gate and a drain to which the output node Node_out may be electrically coupled. The tenth transistor N5 may have a gate and a drain electrically coupled with the source of the ninth transistor N4, and the source may be electrically coupled with the ground terminal VSS. The second divided voltage V_div2 may be outputted from a node electrically coupled with the ninth and tenth transistors N4 and N5.

Operations of the semiconductor apparatus in accordance with an embodiment, configured as mentioned above, will be described below.

Either the first internal voltage generation block 100 or the second internal voltage generation block 200 is activated in response to the enable signal EN. For example, the first internal voltage generation block 100 is activated when the enable signal EN is disabled (i.e., is at a predetermined level), and the second internal voltage generation block 200 is activated when the enable signal EN is enabled (i.e., is at a predetermined level).

Descriptions, relating to various examples, will be made with reference to FIG. 1.

The first internal voltage generation block 100 may be activated when the enable bar signal ENB as the inverted signal of the enable signal EN is enabled, and may generate the internal voltage V_int which may have a voltage level corresponding to the voltage level of the first reference voltage Vref1.

The first comparison unit 110 may compare the voltage levels of the first reference voltage Vref1 and the first divided voltage V_div1 when the enable bar signal ENB is enabled, and may generate the first comparison signal COM1. For example, the first comparison unit 110 may enable the first comparison signal COM1 when the voltage level of the first divided voltage V_div1 is lower than the voltage level of the first reference voltage Vref1. The first comparison unit 110 may disable the first comparison signal COM1 when the voltage level of the first divided voltage V_div1 is higher than the voltage level of the first reference voltage Vref1.

The first driving unit 120 may apply the first external voltage VDD1 to the output node Node_out when the first comparison signal COM1 is enabled. The first driving unit 120 may interrupt the application of the first external voltage VDD1 to the output node Node_out when the first comparison signal COM1 is disabled.

The first voltage division unit 130 may divide the voltage of the output node Node_out and may generate the first divided voltage V_div1. The internal voltage V_int may be outputted from the output node Node_out.

The first internal voltage generation block 100 may be activated when the enable signal EN is disabled. The activated first internal voltage generation block 100 may compare the voltage levels of the first divided voltage V_div1 and the first reference voltage Vref1, and may generate the internal voltage V_int. Therefore, when activated by the enable signal EN, the first internal voltage generation block 100 may generate the internal voltage V_int corresponding to the voltage level of the first reference voltage Vref1.

The second internal voltage generation block 200 may be activated when the enable signal EN is enabled.

The activated second internal voltage generation block 200 may generate the internal voltage V_int which may have a voltage level corresponding to the voltage level of the second reference voltage Vref2.

If the enable signal EN is enabled (i.e., is at a predetermined level), the second comparison unit 210 is activated. The activated second comparison unit 210 may compare the voltage levels of the second reference voltage Vref2 and the second divided voltage V_div2, and may generate the preliminary comparison signal COM_p. For example, the activated second comparison unit 210 may enable the preliminary comparison signal COM_p when the voltage level of the second divided voltage V_div2 is lower than the voltage level of the second reference voltage Vref2. The activated second comparison unit 210 may disable the preliminary comparison signal COM_p when the voltage level of the second divided voltage V_div2 is higher than the voltage level of the second reference voltage Vref2. If the enable signal EN is enabled to a high level, the enable bar signal ENB is disabled to a low level, and, if the enable signal EN is disabled to a low level, the enable bar signal ENB is enabled to a high level.

The level shifter 221-1 may be inputted with the enable bar signal ENB which may be enabled to the low level, that is, the voltage level of the ground terminal VSS, and may output the output control signal Ctrl_out which may be enabled to the low level, that is, the voltage level of the ground terminal VSS.

The comparison signal transmitting section 222 may output the preliminary comparison signal COM_p as the second comparison signal COM2 in response to the enabled output control signal Ctrl_out.

The second driving unit 230 may apply the second external voltage VDD2 to the output node Node_out in response to the second comparison signal COM2. For example, the second driving unit 230 may apply the second external voltage VDD2 to the output node Node_out when the second comparison signal COM2 is enabled to a low level. The second driving unit 230 may interrupt the application of the second external voltage VDD2 to the output node Node_out when the second comparison signal COM2 is disabled to a high level.

The second voltage division unit 240 may divide the voltage of the output node Node_out, that is, the internal voltage V_int, and may generate the second divided voltage V_div2.

If the enable signal EN is disabled, the second internal voltage generation block 200 may be deactivated.

The level shifter 221-1 may shift the voltage level of the enable bar signal ENB which is disabled, and may generate the output control signal Ctrl_out which may be disabled to a high level, that is, the voltage level of the first external voltage VDD1.

If the output control signal Ctrl_out is disabled to the high level, the comparison signal transmitting section 222 may be deactivated and may float the control node Node_ctrl regardless of the preliminary comparison signal COM_p.

The first inverter IV1 may be inputted with the output control signal Ctrl_out which may be disabled to the high level, and may output a signal of a low level to the fourth transistor P2.

The fourth transistor P2 may apply the first external voltage VDD1 to the control node Node_ctrl.

The second driving unit 230 may be turned off in response to the second comparison signal COM2 which is disabled to the voltage level of the first external voltage VDD1. The turned-off second driving unit 230 may electrically decouple the source to which the second external voltage VDD2 is applied and the drain to which the output node Node_out is electrically coupled.

In the case where the voltage level of the internal voltage V_int which is generated as the first internal voltage generation block 100 is activated is higher than the voltage level of the second external voltage VDD2, if the second driving unit 230 is inputted with the second comparison signal COM2 which is disabled to the voltage level of the second external voltage VDD2, the second driving unit 230 may flow leakage current from the output node Node_out to the node which is applied with the second external voltage VDD2.

However, in the internal voltage generation circuit of a semiconductor apparatus in accordance with an embodiment, in the cases where the second internal voltage generation block 200 is deactivated, the second comparison signal COM2 may be generated to have the voltage level of the first external voltage VDD1, whereby it may be possible to prevent leakage current from being caused in the second driving unit 230.

Accordingly, in the internal voltage generation circuit of a semiconductor apparatus in accordance with an embodiment, since leakage current may be prevented, an amount of current consumed to generate an internal voltage may be reduced.

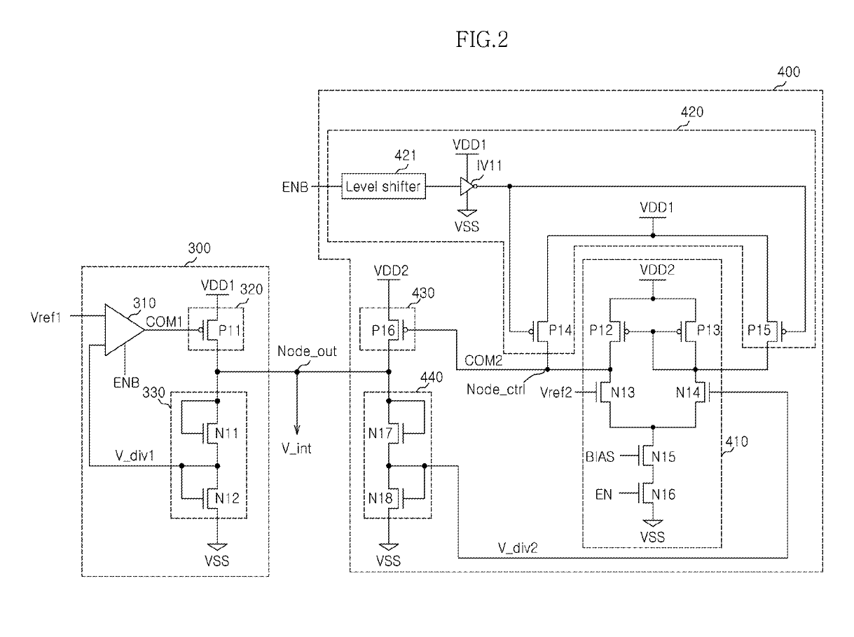

Referring to FIG. 2, an internal voltage generation circuit of a semiconductor apparatus in accordance with an embodiment may include a first internal voltage generation block 300, and a second internal voltage generation block 400.

If one of either the first internal voltage generation block 300 or the second internal voltage generation block 400 is activated in response to an enable signal EN, then the other is deactivated. For example, the second internal voltage generation block 400 may be activated for a predetermined period, and the first internal voltage generation block 300 may be activated during a period excluding the predetermined period. Namely, the predetermined period and the period excluding the predetermined period may be determined by the enable signal EN. An enable bar signal ENB is an inverted signal of the enable signal EN.

The first internal voltage generation block 300 is determined in terms of whether to be activated, in response to the enable bar signal ENB. The activated first internal voltage generation block 300 may generate an internal voltage V_int which may have a voltage level corresponding to the voltage level of a first reference voltage Vref1.

The first internal voltage generation block 300 may include a first comparison unit 310, a first driving unit 320, and a first voltage division unit 330.

The first comparison unit 310 may be activated in response to the enable bar signal ENB. The activated first comparison unit 310 may compare the voltage levels of the first reference voltage Vref1 and a first divided voltage V_div1, and may generate a first comparison signal COM1. For example, the first comparison unit 310 may enable the first comparison signal COM1 when the voltage level of the first divided voltage V_div1 is lower than the voltage level of the first reference voltage Vref1. The first comparison unit 310 may disable the first comparison signal COM1 when the voltage level of the first divided voltage V_div1 is higher than the voltage level of the first reference voltage Vref1.

The first driving unit 320 may apply a first external voltage VDD1 to an output node Node_out in response to the first comparison signal COM1. For example, the first driving unit 320 may apply the first external voltage VDD1 to the output node Node_out when the first comparison signal COM1 is enabled (i.e., is at a predetermined level). The first driving unit 320 may interrupt the application of the first external voltage VDD1 to the output node Node_out when the first comparison signal COM1 is disabled (i.e., is at a predetermined level).

The first driving unit 320 may include a first transistor P11. The first transistor P11 may have a gate that may be inputted with the first comparison signal COM1, a source that may be applied with the first external voltage VDD1, and a drain electrically coupled with the output node Node_out.

The first voltage division unit 330 may divide the internal voltage V_int, that is, the voltage of the output node Node_out, and may generate the first divided voltage V_div1.

The first voltage division unit 330 may include second and third transistors N11 and N12. The second transistor N11 may have a gate and a drain which may be electrically coupled to the output node Node_out. The third transistor N12 may have a gate and a drain electrically coupled with a source of the second transistor N11, and the source may be electrically coupled with a ground terminal VSS.

The second internal voltage generation block 400 may generate the internal voltage V_int having a voltage level corresponding to the voltage level of a second reference voltage Vref2, when the enable signal EN is enabled (i.e., is at a predetermined level).

The second internal voltage generation block 400 may include a second comparison unit 410, a disable control unit 420, a second driving unit 430, and a second voltage division unit 440.

The second comparison unit 410 may be activated when the enable signal EN is enabled (i.e., is at a predetermined level). The activated second comparison unit 410 may compare the voltage levels of the second reference voltage Vref2 with a second divided voltage V_div2, and may generate a second comparison signal COM2. For example, the second comparison unit 410 may enable the second comparison signal COM2 to the voltage level of the ground terminal VSS when the voltage level of the second divided voltage V_div2 is lower than the voltage level of the second reference voltage Vref2. The second comparison unit 410 may disable the second comparison signal COM2 to the voltage level of a second external voltage VDD2 when the voltage level of the second divided voltage V_div2 is higher than the voltage level of the second reference voltage Vref2.

The second comparison unit 410 may include fourth to ninth transistors P12, P13, N13, N14, N15 and N16. The fourth transistor P12 may have a source which may be applied with the second external voltage VDD2. The fifth transistor P13 may have a gate and a drain electrically coupled with the gate of the fourth transistor P12, and a source which may be applied with the second external voltage VDD2. The sixth transistor N13 may have a gate which may be applied with the second reference voltage Vref2, and a drain electrically coupled with the drain of the fourth transistor P12. The seventh transistor N14 may have a gate which may be applied with the second divided voltage V_div2, a drain electrically coupled with the drain of the fifth transistor P13, and a source electrically coupled with a source of the sixth transistor N13. The eighth transistor N15 may have a gate which may be applied with a bias voltage BIAS and a drain electrically coupled with a node electrically coupled with the sources of sixth and seventh transistors N13 and N14. The ninth transistor N16 may have a gate which may be inputted with the enable signal EN, the drain may be electrically coupled with the source of the eighth transistor N15, and the source may be electrically coupled with the ground terminal VSS.

The disable control unit 420 may lock the second comparison signal COM2 to the level of the first external voltage VDD1 regardless of a result of comparing the second reference voltage Vref2 and the second divided voltage V_div2, when the enable bar signal ENB is disabled (i.e., is at a predetermined level). The disable control unit 420 may disable the second comparison signal COM2 regardless of a result of comparing the second reference voltage Vref2 and the second divided voltage V_div2, when the enable bar signal ENB is disabled (i.e., is at a predetermined level). The second comparison signal COM2 which is disabled by the second comparison unit 410 may have the voltage level of the second external voltage VDD2, and the second comparison signal COM2 which is disabled by the disable control unit 420 may have the voltage level of the first external voltage VDD1. The voltage level of the first external voltage VDD1 may be higher than the voltage level of the second external voltage VDD2.

The disable control unit 420 may include a level shifter 421, an inverter IV11, and tenth and eleventh transistors P14 and P15. The level shifter 421 may output the enable bar signal ENB which may transition to the voltage level of the second external voltage VDD2 or the voltage level of the ground terminal VSS, as a signal which transitions to the voltage level of the first external voltage VDD1 or the voltage level of the ground terminal VSS. The inverter IV11 may be applied with the first external voltage VDD1 and the voltage of the ground terminal VSS, and may be inputted with the output signal of the level shifter 421. The tenth transistor P14 may have a gate which may be inputted with the output signal of the inverter IV11, a source which may be applied with the first external voltage VDD1, and a drain electrically coupled with a control node Node_ctrl. The control node Node_ctrl is a node from which the output signal of the second comparison unit 410 may be outputted and is a node from which the second comparison signal COM2 may be outputted. Also, the control node Node_ctrl is a node at which the fourth and sixth transistors P12 and N13 are electrically coupled. The eleventh transistor P15 may have a gate which may be inputted with the output signal of the inverter IV11, a source which may be applied with the first external voltage VDD1, and a drain electrically coupled with a node electrically coupled between the fifth and seventh transistors P13 and N14.

The second driving unit 430 may apply the second external voltage VDD2 to the output node Node_out in response to the second comparison signal COM2. For example, the second driving unit 430 may apply the second external voltage VDD2 to the output node Node_out when the second comparison signal COM2 is enabled (i.e., is at a predetermined level), and may interrupt the application of the second external voltage VDD2 to the output node Node_out when the second comparison signal COM2 is disabled (i.e., is at a predetermined level).

The second driving unit 430 may include a twelfth transistor P16. The twelfth transistor P16 may have a gate which may be inputted with the second comparison signal COM2, a source which may be applied with the second external voltage VDD2, and a drain electrically coupled with the output node Node_out.

The second voltage division unit 440 may divide the voltage of the output node Node_out, that is, the internal voltage V_int, and may generate the second divided voltage V_div2.

The second voltage division unit 440 may include thirteenth and fourteenth transistors N17 and N18. The thirteenth transistor N17 may have a gate and a drain electrically coupled with the output node Node_out. The fourteenth transistor N18 may have a gate and a drain electrically coupled with the source of the thirteenth transistor N17, and a source electrically coupled with the ground terminal VSS.

Operations of the semiconductor apparatus in accordance with an embodiment, configured as mentioned above, will be described below.

In response to the enable signal EN, only one internal voltage generation block of the first internal voltage generation block 300 and the second internal voltage generation block 400 is activated.

The first internal voltage generation block 300 may be activated in response to the enable signal EN. For example, the first internal voltage generation block 300 may be activated when the enable bar signal ENB is enabled (i.e., is at a predetermined level), and may generate the internal voltage V_int which may have a voltage level corresponding to the voltage level of the first reference voltage Vref1.

The first comparison unit 310 may compare the voltage levels of the first reference voltage Vref1 and the first divided voltage V_div1 when the enable bar signal ENB is enabled (i.e., is at a predetermined level), and may generate the first comparison signal COM1. For example, the first comparison unit 310 may enable the first comparison signal COM1 when the enable bar signal ENB is enabled and the voltage level of the first divided voltage V_div1 is lower than the voltage level of the first reference voltage Vref1. The first comparison unit 310 may disable the first comparison signal COM1 when the enable bar signal ENB is enabled and the voltage level of the first divided voltage V_div1 is higher than the voltage level of the first reference voltage Vref1.

The first driving unit 320 may apply the first external voltage VDD1 to the output node Node_out in response to the first comparison signal COM1. For example, the first driving unit 320 may apply the first external voltage VDD1 to the output node Node_out when the first comparison signal COM1 is enabled (i.e., is at a predetermined level). The first driving unit 320 may interrupt the application of the first external voltage VDD1 to the output node Node_out when the first comparison signal COM1 is disabled (i.e., is at a predetermined level).

The first voltage division unit 330 may divide the voltage of the output node Node_out, that is, the internal voltage V_int, and may generate the first divided voltage V_div1.

The second internal voltage generation block 400 may be activated in response to the enable signal EN. The activated second internal voltage generation block 400 may generate the internal voltage V_int which has a voltage level corresponding to the voltage level of the second reference voltage Vref2.

The second comparison unit 410 may compare the voltage levels of the second reference voltage Vref2 and the second divided voltage V_div2 when the enable signal EN is enabled (i.e., is at a predetermined level), and may generate the second comparison signal COM2. For example, the second comparison unit 410 may enable the second comparison signal COM2 when the enable signal EN is enabled and the voltage level of the second divided voltage V_div2 is lower than the voltage level of the second reference voltage Vref2. The second comparison unit 410 may disable the second comparison signal COM2 when the enable signal EN is enabled and the voltage level of the second divided voltage V_div2 is higher than the voltage level of the second reference voltage Vref2. The second comparison signal COM2 may have the voltage level of the ground terminal VSS when it is enabled, and may have the voltage level of the second external voltage VDD2 when it is disabled.

The disable control unit 420 may disable the second comparison signal COM2 to the voltage level of the first external voltage VDD1 when the enable bar signal ENB is disabled (i.e., is at a predetermined level).

The second driving unit 430 may apply the second external voltage VDD2 to the output node Node_out when the second comparison signal COM2 is enabled (i.e., is at a predetermined level), and may interrupt the application of the second external voltage VDD2 to the output node Node_out when the second comparison signal COM2 is disabled (i.e., is at a predetermined level).

The second voltage division unit 440 may divide the voltage of the output node Node_out, that is, the internal voltage V_int, and may generate the second divided voltage V_div2.

In the cases where the voltage level of the internal voltage V_int which is generated as the first internal voltage generation block 300 is activated is higher than the voltage level of the second external voltage VDD2, if the second driving unit 430 is inputted with the second comparison signal COM2 which is disabled to the voltage level of the second external voltage VDD2, the second driving unit 430 may flow leakage current from the output node Node_out to the node which is applied with the second external voltage VDD2.

However, in the internal voltage generation circuit of a semiconductor apparatus in accordance with an embodiment, in the cases where the second internal voltage generation block 400 is deactivated, the second comparison signal COM2 may be generated to have the voltage level of the first external voltage VDD1, whereby it may be possible to prevent leakage current from being caused in the second driving unit 430.

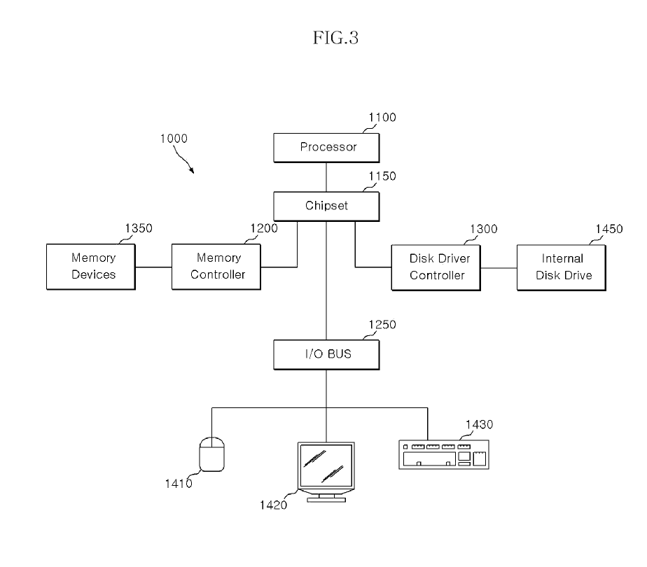

The internal voltage generation circuit of a semiconductor apparatus as discussed above (see FIGS. 1-2) or generally an internal voltage generation circuit are particular useful in the design of memory devices, processors, and computer systems. For example, referring to FIG. 3, a block diagram of a system employing the internal voltage generation circuit of a semiconductor apparatus in accordance with the embodiments are illustrated and generally designated by a reference numeral 1000. The system 1000 may include one or more processors or central processing units (“CPUs”) 1100. The CPU 1100 may be used individually or in combination with other CPUs. While the CPU 1100 will be referred to primarily in the singular, it will be understood by those skilled in the art that a system with any number of physical or logical CPUs may be implemented. A chipset 1150 may be operably coupled to the CPU 1100. The chipset 1150 is a communication pathway for signals between the CPU 1100 and other components of the system 1000, which may include a memory controller 1200, an input/output (“I/O”) bus 1250, and a disk drive controller 1300. Depending on the configuration of the system, any one of a number of different signals may be transmitted through the chipset 1150, and those skilled in the art will appreciate that the routing of the signals throughout the system 1000 can be readily adjusted without changing the underlying nature of the system.

As stated above, the memory controller 1200 may be operably coupled to the chipset 1150. The memory controller 1200 may include at least one internal voltage generation circuit of a semiconductor apparatus as discussed above with reference to FIGS. 1-2 or generally an internal voltage generation circuit. Thus, the memory controller 1200 can receive a request provided from the CPU 1100, through the chipset 1150. In alternate embodiments, the memory controller 1200 may be integrated into the chipset 1150. The memory controller 1200 may be operably coupled to one or more memory devices 1350. In an embodiment, the memory devices 1350 may include the at least one internal voltage generation circuit of a semiconductor apparatus as discussed above with relation to FIGS. 1-2 or generally an internal voltage generation circuit, the memory devices 1350 may include a plurality of word lines and a plurality of bit lines for defining a plurality of memory cell. The memory devices 1350 may be any one of a number of industry standard memory types, including but not limited to, single inline memory modules (“SIMMs”) and dual inline memory modules (“DIMMs”). Further, the memory devices 1350 may facilitate the safe removal of the external data storage devices by storing both instructions and data.

The chipset 1150 may also be coupled to the I/O bus 1250. The I/O bus 1250 may serve as a communication pathway for signals from the chipset 1150 to I/O devices 1410, 1420 and 1430. The I/O devices 1410, 1420 and 1430 may include a mouse 1410, a video display 1420, or a keyboard 1430. The I/O bus 1250 may employ any one of a number of communications protocols to communicate with the I/O devices 1410, 1420, and 1430. Further, the I/O bus 1250 may be integrated into the chipset 1150.

The disk drive controller 1450 (i.e., internal disk drive) may also be operably coupled to the chipset 1150. The disk drive controller 1450 may serve as the communication pathway between the chipset 1150 and one or more internal disk drives 1450. The internal disk drive 1450 may facilitate disconnection of the external data storage devices by storing both instructions and data. The disk drive controller 1300 and the internal disk drives 1450 may communicate with each other or with the chipset 1150 using virtually any type of communication protocol, including all of those mentioned above with regard to the I/O bus 1250.

It is important to note that the system 1000 described above in relation to FIG. 3 is merely one example of a system employing the internal voltage generation circuit of a semiconductor apparatus as discussed above with relation to FIGS. 1-2. In alternate embodiments, such as cellular phones or digital cameras, the components may differ from the embodiments illustrated in FIG. 3.

While various embodiments have been described above, it will be understood to those skilled in the art that the embodiments described are by way of example only. Accordingly, the internal voltage generation circuits of the semiconductor apparatuses described herein should not be limited based on the described embodiments.

What is claimed is:

1. An internal voltage generation circuit comprising:
a first internal voltage generation block configured for receiving an enable signal; and
a second internal voltage generation block coupled with the first internal voltage generation block,
wherein, in response to the enable signal, either the first internal voltage generation block or the second internal voltage generation block is activated, and the other is deactivated,
wherein if the first internal voltage generation block is activated, then the first internal voltage generation block is applied with a first external voltage and generates an internal voltage which has a voltage level corresponding to a voltage level of a first reference voltage,
wherein if the second internal voltage generation block is activated, then the second internal voltage generation block is applied with a second external voltage and generates the internal voltage having a voltage level corresponding to a voltage level of a second reference voltage, and compares the voltage levels of the second reference voltage and the internal voltage and generates a comparison signal, and
wherein the second internal voltage generation block disables the comparison signal when the first internal voltage generation block is activated, and a voltage level of the disabled comparison signal is a voltage level of the first external voltage.

2. The internal voltage generation circuit according to claim 1, wherein the first and second internal voltage generation blocks are commonly electrically coupled with each other at an output node, and the internal voltage is outputted from the output node.

3. The internal voltage generation circuit according to claim 1,
wherein the second internal voltage generation block generates the comparison signal having the voltage level of the first external voltage when the first internal voltage generation block is activated, and
wherein the second internal voltage generation block transitions the comparison signal to the second external voltage or a voltage of a ground terminal when the first internal voltage generation block is deactivated.

4. The internal voltage generation circuit according to claim 3, wherein the second internal voltage generation block comprises:
a comparison unit configured to compare voltage levels of the second reference voltage with a divided voltage when the enable signal is enabled, and generate a preliminary comparison signal;
a comparison signal control unit configured to output the preliminary comparison signal as the comparison signal in response to the enable signal, and control the voltage level of the disabled comparison signal;
a driving unit configured to apply the second external voltage to the output node in response to the comparison signal; and
a voltage division unit configured to divide a voltage of the output node and generate the divided voltage.

5. The internal voltage generation circuit according to claim 4, wherein the comparison signal control unit comprises:
a disable voltage control section configured to shift, when an enable bar signal as an inverted signal of the enable signal is disabled, a voltage level of the disabled enable bar signal to a first external voltage and output an output control signal, and disable the comparison signal when the enable bar signal is disabled; and
a comparison signal transmitting section configured to prevent the preliminary comparison signal from being outputted as the comparison signal when the output control signal is disabled, and output the preliminary comparison signal as the second comparison signal when the output control signal is enabled,
wherein the comparison signal which is disabled as the enable bar signal is disabled is the voltage level of the first external voltage.

6. The internal voltage generation circuit according to claim 5, wherein the comparison signal transmitting section comprises:
an inverter configured for receiving the preliminary comparison signal;
a first transistor having a source configured for receiving the second external voltage, a gate configured for receiving the output control signal;
a second transistor having a source coupled with a drain of the first transistor, and a gate configured for receiving an output of the inverter; and
a third transistor having a drain coupled with a drain of the second transistor, a gate coupled with the gate of the second transistor and configured to receive the output of the second inverter, and a source coupled with the ground terminal,
wherein the drain of both the second and third transistors are coupled with the driving unit and the disable voltage control section.

7. The internal voltage generation circuit according to claim 3, wherein the second internal voltage generation block comprises:
a comparison unit configured to compare voltage levels of the second reference voltage and a divided voltage when the enable signal is enabled, and generate the comparison signal;
a disable control unit configured to disable the comparison signal when an enable bar signal as an inverted signal of the enable signal is disabled;
a driving unit configured to apply the second external voltage to the output node in response to the comparison signal; and
a voltage division unit configured to divide a voltage of the output node and generate the divided voltage,
wherein the comparison signal which is disabled as the enable bar signal is disabled is the voltage level of the first external voltage.

8. An internal voltage generation circuit, comprising:
a first internal voltage generation block including:
a first comparison unit configured to compare voltage levels of a first reference voltage and a first divided voltage when an enable bar signal is enabled and generate a first comparison signal,
a first driving unit configured to apply a first external voltage to an output node in response to the first comparison signal, and
a first voltage division unit configured to divide a voltage of the output node and generate the first divided voltage; and
a second internal voltage generation block including:
a second comparison unit configured to compare voltage levels of a second reference voltage and a second divided voltage in response to an enable signal and generate a preliminary comparison signal,
a comparison signal control unit configured to output the preliminary comparison signal as a second comparison signal in response to the enable bar signal,
a second driving unit configured to apply a second external voltage to the output node in response to the second comparison signal, and
a second voltage division unit which is configured to divide a voltage of the output node and generate the second divided voltage.

9. The internal voltage generation circuit according to claim 8, wherein the enable bar signal is an inverted signal of the enable signal.

10. The internal voltage generation circuit according to claim 9, wherein the comparison signal control unit outputs the preliminary comparison signal as the second comparison signal, the second comparison signal transitions to the second external voltage or a voltage level of a ground terminal or disables the second comparison signal, in response to the enable bar signal,
wherein the disabled second comparison signal is a voltage level of the first external voltage.

11. An internal voltage generation circuit, comprising:
a first internal voltage generation block configured for receiving a first external voltage, and for generating an internal voltage; and
a second internal voltage generation block configured for receiving a second external voltage, and for generating the internal voltage in response to a comparison signal for a predetermined period,
wherein the second internal voltage generation block generates the comparison signal which transitions to the second external voltage and a voltage level of a ground terminal, for the predetermined period, and locks the comparison signal to a voltage level of the first external voltage, for a period excluding the predetermined period, and
wherein an output terminal of the first internal voltage generation block and an output terminal of the second internal voltage generation block are commonly electrically coupled to an output node, and the internal voltage is outputted from the output node.

12. The internal voltage generation circuit according to claim 11, wherein the predetermined period is a period in which the first internal voltage generation block interrupts generation of the internal voltage, and the period excluding the predetermined period is a period in which the first internal voltage generation block generates the internal voltage.

13. The internal voltage generation circuit according to claim 12, wherein the second internal voltage generation block comprises:
a comparison unit configured for receiving the second external voltage and the voltage of the ground terminal, to be activated in response to an enable signal, to compare voltage levels of a reference voltage and a divided voltage, and to generate the comparison signal;
a driving unit configured to apply the second external voltage to the output node in response to the comparison signal;
a voltage division unit configured to divide a voltage of the output node and generate the divided voltage; and
a disable control unit configured to lock a voltage level of the comparison signal to a voltage level of the first external voltage in response to the enable signal.

14. The internal voltage generation circuit according to claim 13, wherein the first internal voltage generation block is activated in response to the enable signal, and generates the internal voltage when activated.
